(19) United States
(12) Patent Application Publication
(10) Pub. No.: US 2025/0323249 A1
(43) Pub. Date: Oct. 16, 2025

(54) NEGATIVE ACTIVE MATERIAL, METHOD OF PREPARING SAME, AND RECHARGEABLE LITHIUM BATTERY INCLUDING SAME

(71) Applicant: SAMSUNG SDI CO., LTD., Yongin-si (KR)

(72) Inventors: Eunji KANG, Yongin-si (KR); Youngugk KIM, Yongin-si (KR); Deok-Hyun KIM, Yongin-si (KR); Doori OH, Yongin-si (KR); Yookyung KIM, Yongin-si (KR); Banseok LEE, Yongin-si (KR)

(73) Assignee: SAMSUNG SDI CO., LTD., Yongin-si (KR)

(21) Appl. No.: 19/171,799

(22) Filed: Apr. 7, 2025

(30) Foreign Application Priority Data
Apr. 12, 2024 (KR) 10-2024-0049636

(51) Int. Cl. H01M 4/36; C01B 33/12; H01M 4/38; H01M 4/48; H01M 4/587; H01M 10/052

(52) U.S. Cl. CPC H01M 4/366; C01B 33/12; H01M 4/386; H01M 4/48; H01M 4/587; H01M 10/052; C01P 2002/02; C01P 2004/61; C01P 2004/80; C01P 2006/16; C01P 2006/40

(57) ABSTRACT

Disclose are a negative active material, a method of preparing the negative active material, and a rechargeable lithium battery including the negative active material. The negative active material includes secondary particles including aggregated primary particles, the primary particles including a substrate in which pores are formed, the pores being filled with an amorphous Si, and an amorphous carbon coating layer on a surface of the secondary particle, wherein the primary particles have a size in a range of about 1 μm to about 15 μm, and the negative active material has a porosity in a range of about 2% or less.

### CROSS-REFERENCE TO RELATED APPLICATION

This application claims the benefit of priority to Korean Patent Application No. 10-2024-0049636 filed in the Korean Intellectual Property Office on Apr. 12, 2024, the entire contents of which are incorporated herein by reference.

### BACKGROUND

### (a) Field

Example embodiments relate to a negative active material, a method of preparing the negative active material, and a rechargeable lithium battery including the negative active material.

### (b) Description of the Related Art

With increasing use of electronic devices that use batteries such as, e.g., mobile phones, laptop computers, electric vehicles, and the like, demand for smaller, lighter and relatively high-capacity rechargeable lithium batteries is increasing. Improving performance of rechargeable lithium batteries may thus be advantageous.

Rechargeable lithium batteries typically include a positive electrode and a negative electrode including an active material capable of intercalating and deintercalating lithium ions, and an electrolyte solution, and electrical energy is produced by oxidation and reduction reactions when lithium ions are intercalated/deintercalated at the positive and negative electrodes.

### SUMMARY

One or more example embodiments include a negative active material exhibiting desired or improved cycle-life characteristic.

Another example embodiment includes a method of preparing the negative active material.

Still another example embodiment includes a rechargeable lithium battery including the negative active material.

One or more example embodiments includes a negative active material including secondary particles where primary particles are aggregated, the primary particles including a substrate in which pores are formed and amorphous Si fills the pores; and an amorphous carbon coating layer on a surface of the secondary particle, wherein the primary particles have a size in a range of about 1 μm to about 15 μm, and the negative active material has a porosity of about 2% or less.

Another example embodiment includes a method of preparing a negative active material, the method including vapor coating Si on a porous substrate in which pores are formed to prepare primary particles filled with amorphous Si in the pores; aggregating the primary particles to prepare secondary particles; and forming an amorphous carbon coating layer on the secondary particles.

Another example embodiment includes a rechargeable lithium battery including a negative electrode that includes the negative active material, a positive electrode, and an electrolyte.

A negative active material according to one or more example embodiments may exhibit high strength and desired or improved dynamic performances.

### BRIEF DESCRIPTION OF THE DRAWINGS

FIG. 1 is a schematic view illustrating the negative active material according to one or more example embodiments.

FIG. 2 to FIG. 5 are a cross-sectional view schematically illustrating rechargeable lithium batteries according to some example embodiment.

### DETAILED DESCRIPTION

Hereinafter, example embodiments are described in detail. However, these embodiments are examples, the present disclosure is not limited thereto, and the present disclosure is defined by the scope of claims.

Terms used in the specification are used to explain example embodiments, but are not intended to limit the present disclosure. Expressions in the singular include expressions in plural unless the context clearly dictates otherwise.

The term “combination thereof may include a mixture, a laminate, a complex, a copolymer, an alloy, a blend, a reactant of constituents.

The term “comprise,” “include” or “have” are intended to designate that the performed characteristics, numbers, step, constituted elements, or a combination thereof is present, but it should be understood that the possibility of presence or addition of one or more other characteristics, numbers, steps, constituted element, or a combination are not to be precluded in advance.

The drawings show that the thickness is enlarged in order to clearly show the various layers and regions, and the same reference numerals are given to similar parts throughout the specification. When an element, such as a layer, a film, a region, a plate, and the like is referred to as being “on” or “over” another part, it may include cases where it is “directly on” another element, but also cases where there is another element in between. In contrast, when an element is referred to as being “directly on” another element, there are no intervening elements present.

Herein, “layer” includes a shape totally formed on the entire surface or a shape formed on partial surface, when viewed from a plane view.

Herein, “or” is not to be construed as an exclusive meaning, for example, “A or B” is construed to include A, B, A+B, and the like.

As used herein, when a definition is not otherwise provided, a particle diameter or a particle size may be an average particle diameter. The average particle diameter indicates an average value of the diameter of the particles depending on a cumulative volume in the particle size distribution of particles included in the negative active material. The average particle size (D50) may be measured by a method well known to those skilled in the art, for example, by a particle size analyzer, or by a transmission electron microscopic image, or a scanning electron microscopic image. In some example embodiments, a dynamic light-scattering measurement device is used to perform a data analysis, and the number of particles is counted for each particle size range, and from this, the average particle diameter (D50) value may be readily obtained through a calculation.

A negative active material according to one or more example embodiments includes secondary particles where primary particles are aggregated, the primary particles comprising a substrate in which pores are formed and amorphous Si filled in the pores; and an amorphous carbon coating layer positioned on a surface of the secondary particle, wherein the primary particles have a size in a range of about 1 μm to about 15 μm, and the negative active material has a porosity of about 2% or less. A size of the primary particles is in a range of about 1 μm to about 15 μm and the porosity of the negative active material is about 2% or less.

When the terms “about” or “substantially” are used in this specification in connection with a numerical value, it is intended that the associated numerical value include a tolerance of ±10% around the stated numerical value. When ranges are specified, the range includes all values therebetween such as increments of 0.1%.

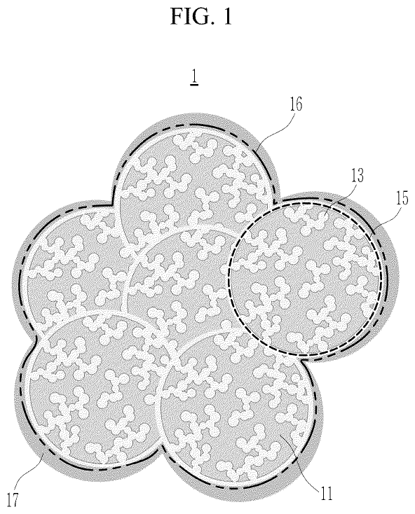

FIG. 1 schematically illustrates the negative active material according to one or more example embodiments. As shown in FIG. 1, the negative active material 1 includes primary particles 15 including a substrate 11 in which pores are formed, and amorphous Si 13 and secondary particles 16 where the primary particles 15 are aggregated. An amorphous carbon coating layer 17 is on the surface of the secondary particles.

In examples, the negative active material has a porosity of about 2% or less, e.g., in a range of about 0.1% to about 2.0%, which is low porosity. This low porosity of the negative active material indicates that silicon is sufficiently filled in the pores of the substrate. The porosity of about 1% or less represent that the inside of the pores formed in the substrate is substantially and almost filled with silicon, indicating almost no empty spaces in the substrate.

If the porosity of the negative active material is about 2% or less, e.g., the dense structure is included, enhanced cycle-life characteristics may be exhibited.

The porosity of the negative active material may be determined by measuring the pore volume of the negative active material through a specific surface area measurement device, and multiplying the pore volume by the true density to calculate a pore volume fraction (%) of the secondary particles. This physical property is also maintained in the battery using the negative active material.

This may be obtained by separating the negative active material from the negative electrode which is separated from disassembled battery after formation charging and discharging, removing the binder and organic material, or the like from the negative active material, drying the negative active material to obtain a negative active material power, and measuring the porosity for the powder by the above-identified procedures.

In one or more example embodiments, Si is amorphous, and the amorphous Si may exhibit reduced volume expansion during charging and discharging and improved cycle-life characteristics, compared to crystalline Si. In one or more example embodiments, the amorphous Si may be confirmed by measuring TEM or X-ray diffraction peak (XRD). In case of measuring TEM, Si exhibiting no crystal lattice stripes may indicate amorphous silicon. In the case of measuring an XRD using a CuKα ray as a target ray, an appearance of a broad peak may indicate amorphous silicon. The Si filled in the pore may be or include elemental Si.

The size of the primary particles may be in a range of about 1 μm to about 15 μm, about 3 μm to about 14 μm, or about 4 μm to about 13 μm. Because the size of the primary particles is small within any of the above ranges, silicon may be substantially completely filled in the pores, even though the pores are located at a middle of the porous substrate.

In the negative active material according to one or more example embodiments, the size of the primary particles is relevant, and the size of the secondary particles may be appropriately adjusted.

The negative active material according to one or more example embodiments includes secondary particles where at least one such primary particles are agglomerated. Because the negative active material includes secondary particles where one or more primary particles are agglomerated, silicon may be substantially uniformly distributed in the center (e.g., middle region) of the negative active material, compared to the single particles which are not agglomerated. This enables to provide high capacity and improvements in long-term cycle performance. Silicon is located by filling the pores of the substrate, and some of which may be exposed outward, may be covered with an amorphous carbon precursor that is used in the agglomeration, thereby sufficiently reducing or preventing the direct contact of Si with the electrolyte. Thus, the generation of H₂ gas due to direct contact of the Si with the electrolyte may be reduced or prevented.

The size of the pore formed in the substrate may be in a range of about 1 nm to about 100 nm, about 10 nm to about 100 nm, about 1 nm to about 80 nm, or about 1 nm to about 50 nm. If the size of the pore formed in the substrate is within any of the above ranges, the size of silicon filled in the pore is within nanometers within the above range, thereby reducing the absolute volume value expanded during charging and discharging. This enables to reduce or suppress loss of capacity and efficiency, and to improve cycle-life characteristics. The size of the pores may be an average size.

The porosity of the substrate may be in a range of about 30% to about 90%, about 40% to about 80%, or about 50% to about 70%. If the porosity of the substrate is within any of the above ranges, the amount of silicon filled inside is enlarged, thereby exhibiting substantially higher capacity. The porosity of the substrate represents a porosity of the substrate before filling amorphous Si therein.

In one or more example embodiments, an amount of the amorphous Si may be, based on 100 wt % of the negative active material, in a range of about 19 wt % to about 70 wt %, about 30 wt % to about 60 wt %, or about 40 wt % to about 50 wt %. If the amount of amorphous Si is included in any of the above ranges, the exposure of Si to the surface of the negative active material to undergo a side reaction with the electrolyte may be effectively reduced or removed.

The substrate may include at least one of Al₂O₃, ZrO₂, SiO₂, TiO₂, SiC, C (carbon), or a combination thereof. For example, the substrate may be or include at least one of activated carbon, silica gel, or zeolite.

An amount of the substrate may be, based on 100 wt % of the negative active material, in a range of about 29 wt % to about 80 wt %, about 40 wt % to about 70 wt %, or about 50 wt % to about 60 wt %. If the amount of the substrate is within any of the above ranges, the deposition of Si may be appropriately performed, and a substantially higher capacity may be secured after deposition.

In the amorphous carbon coating layer, amorphous carbon may be or include at least one of pitch carbon, soft carbon, hard carbon, mesophase pitch carbide, sintered coke, carbon fiber, or a combination thereof.

A thickness of the amorphous carbon coating layer may be more than about 0 nm and about 2 μm or less, in a range of about 1 nm to about 2000 nm, or about 1 nm to about 1000 nm. The thickness indicates a thickness of amorphous carbon on the surface of the core. If amorphous carbon is unevenly distributed, the thickness may indicate a length of the thickest amorphous carbon. In one or more example embodiments, the thickness may be an average thickness. If the thickness of the amorphous carbon coating layer is within any of the above ranges, the charge and discharge efficiency and rate characteristic may be enhanced.

The secondary particles may further include amorphous carbon.

In the negative active material according to one or more example embodiments, an amount of amorphous carbon may be, based on 100 wt % of the negative active material, in a range of about 1 wt % to about 25 wt %, about 2 wt % to about 20 wt %, or about 3 wt % to about 15 wt %. The amount of amorphous carbon may be or include an amount of amorphous carbon included in the amorphous carbon coating layer. In another example embodiment, when the secondary particles further include amorphous carbon, the amount of amorphous carbon may be the total amount included in the amorphous carbon coating layer and the secondary particles. For example, the amount may be or include an amount of amorphous carbon included in the negative active material, regardless of the inclusion of amorphous carbon in any position.

If the amount of amorphous carbon satisfies any of the above ranges, silicon in the pores, which may be located on the outward of the supporter, the generation of H₂ gas by side-reaction of the silicon with the electrolyte may be reduced or prevented, and the long-term cycle performances may be enhanced.

The negative active material according to one or more example embodiments may be prepared by the following example procedures.

A porous substrate with small particle diameter is prepared. The porous substrate with small particle diameter may be a substrate with an average particle diameter (D50) in a range of about 3 μm to about 20 μm, or may be formed by pulverizing a porous substrate with a large average particle diameter (D50) to prepare a porous substrate with an average particle diameter in a range of about 3 μm to about 20 μm.

The porous substrate is a substrate in which pores are formed, and the porosity may be in a range of about 30% to about 90%, about 40% to about 80%, or about 50% to about 70%. A size of the pores may be about 1 nm to about 100 nm, about 1 nm to about 80 nm, or about 1 nm to about 50 nm.

The porous substrate may be or include a porous substrate available commercially, or may be used via aerogel procedure, or a spray-drying procedure. In another example embodiments, the porous substrate may be or include at least one of activated carbon, silica gel, or zeolite. The porous substrate may be further subjected to sieving procedure using a sieve.

The aerogel or spray-drying procedures will be illustrated hereinafter.

In the aerogel procedure, water glass including SiO₂ is diluted with water to prepare a water glass solution including SiO₂. The water glass may further include at least one of Na₂O, K₂O, and Fe₂O₃ in addition to SiO₂. In the water glass, an amount of SiO₂ may be in a range of about 20 wt % to about 40 wt % based on the total 100 wt % of the water glass, and in the diluted SiO₂-included water glass solution, an amount of SiO₂ may be in a range of about 3 wt % to about 6 wt % based on the total 100 wt % of the diluted SiO₂-included water glass solution. If the amount of SiO₂ included in the water glass is within any of the above ranges, the inside pore may be freely controlled.

In one or more example embodiments, among the components included in the water glass, the amount of compounds other than the amount of SiO₂ may be suitably adjusted.

The water glass solution is mixed with an acid solution to prepare a silica sol. Through the mixing with the acid solution, a sodium component included in the water glass solution may be removed. If the mixing of the water glass solution with the acid solution is not performed, for example, a neutralization with the solution of the acid is not performed, the strong alkali water glass may not prepare a silica sol, thereby preparing no objective negative active material. For example, it may be challenging to prepare a porous supporter having sufficient pores, and thus it may be challenging to fill silicon in the pores of the porous supporter at a sufficient amount.

The acid solution may be or include a solution including an acid such as at least one of hydrochloric acid, nitric acid, sulfuric acid, acetic acid, fluoric acid, or a combination thereof, and include water as a solvent. The acid solution may have a concentration in a range of about 0.2 M to about 3 M.

A mixing ratio of the water glass solution and the acid solution may be in a range of about 8:2 to about 6:2 by a volume ratio, or about 6:1 to about 6:0.5 by a volume ratio.

Thereafter, an alcohol is added to the silica sol and agitate to gel, thereby obtaining a wet gel. The alcohol may be added in an amount corresponding to a range of about 40% to about 60% based on the volume of the silica sol. When the used amount of the alcohol is within the above range, more uniform gelation may be induced. A washing of the wet gel may be further performed.

The wet gel may be modified into a hydrophobic surface by using a non-polar organic solvent and an organic silane compound. The modification may be performed by mixing the wet gel with the non-polar organic solvent and the organic silane compound. The mixing may be performed for a period of time in a range of about 2 hours to about 4 hours. According to the mixing, a solvent substitution reaction may occur, and the surface of the gel may be modified to be hydrophobic.

Before mixing, washing the wet gel after separately collecting may be further performed.

The non-polar organic solvent may be or include a solvent being capable of modifying a surface of a target material into a hydrophobic surface. The solvent may be or include at least one of isopropyl alcohol, n-hexane, n-heptane, xylene, trimethylchlorosilane, cyclohexane, or a combination thereof.

The organicsilane compound may include at least one of trimethylchlorosilane, hexamethyldisilazane, methyltrimethoxysilane, trimethylethoxysilane, ethyltriethoxysilane, phenyltriethoxysilane, or a combination thereof.

In the mixing, a mixing ratio of the wet gel, the non-polar organic solvent, and the organic silane compound may be in a range of about 1:1:1 to about 1:1:0.5 by volume, or about 1:0.5:0.5 by volume to about 1:0.5:0.25 by volume.

Thereafter, the prepared surface modified gel is dried to prepare a porous inorganic supporter. The drying may be performed at a temperature in a range of about 50° C. to about 180° C., or about 70° C. to about 160° C. The drying may be performed for a period of time of about 1 hour to 5 hours, or about 1 hour to about 3 hours.

In another example embodiment, the drying may be performed by 2 steps including a low temperature drying and a high temperature drying. The low temperature drying may be performed at a temperature in a range of about 50° C. to about 80° C. for about 1 hour to about 2 hours, and the high temperature drying may be performed at about 140° C. to about 170° C. for about 1 hour to about 3 hours.

The drying may be performed under atmospheric pressure.

Si is vapor coated on the porous substrate to prepare primary particles in which amorphous Si is filled in the pores. The vapor coating may be a vapor deposition using a silicon source material. The silicon source material may be or include at least one of a SiH₄ gas, a Si₂H₆ gas, a Si₃H₈ gas, or a combination thereof.

The vapor deposition may be a chemical vapor deposition (CVD).

The vapor deposition may be performed at a temperature at which silicon to be deposited is converted into amorphous Si (a-Si), and for example, in a range of about 400° C. to about 700° C. If the vapor deposition is performed at a temperature of more than about 700° C., silicon to be deposited is crystallized, thereby increasing the volume expansion during charge and discharge, and deteriorating the cycle-life characteristics, which is undesirable. If the vapor deposition is performed at a temperature of less than about 400° C., the silicon raw material is not readily decomposed and silicon raw material remains and forms impurities in the porous supporter, which is undesirable.

In the vapor deposition, the flow rate of gas which is the silicon source material may be in a range of about 1 sccm to about 500 sccm, about 10 sccm to about 400 sccm, or about 50 sccm to about 300 sccm. The sccm is standard cc per minute and indicates gas flow rate at which molecular particles of 2.7×10¹⁹ per minute, and is measured at about 0° C. and about 1 atm. By the vapor deposition process, silicon may be filled in the pore of the porous substrate.

The deposition may be carried out for a period in a range of about 0.5 hours to about 5 hours, or for about 0.5 hours to about 3 hours.

The particle diameter of the primary particles prepared by the procedures may be in a range of about 1 μm to about 15 μm, about 3 μm to about 14 μm, or about 4 μm to about 13 μm.

The prepared primary particles are agglomerated to prepare secondary particles. The agglomeration may be carried out by using an amorphous carbon precursor. For example, the primary particles are mixed with the amorphous carbon precursor and heat-treated. The heat treatment temperature may be in a range of about 600° C. to about 1000° C.

The amorphous carbon precursor is not particularly limited as long as it is a material that prepares amorphous carbon by heat-treatment, but may include at least one of petroleum coke, coal coke, petroleum pitch, coal pitch, green cokes, or a combination thereof.

A used amount of the amorphous carbon precursor may be, based on 100 wt % of the primary particles, in a range of about 1 wt % to about 15 wt %, about 1 wt % to about 13 wt %, or about 2 wt % to about 10 wt %. If the used amount of the amorphous carbon precursor is within any of the above ranges, the primary particles are sufficiently agglomerated, thereby appropriately preparing secondary particles.

Thereafter, an amorphous carbon coating layer is formed on the prepared secondary particles. The formation of the amorphous carbon coating layer may be carried out by vapor coating with an amorphous carbon precursor gas, or by mixing the secondary particles with the amorphous carbon precursor and heat-treating.

The amorphous carbon precursor gas may be or include a methane (CH₄) gas, an ethylene (C₂H₄) gas, an acetylene (C₂H₂) gas, a propane (C₃H₈) gas, a propylene (C₃H₆) gas, or a combination thereof, and the amorphous carbon precursor may be or include at least one of petroleum coke, coal coke, petroleum pitch, coal pitch, green coke, or a combination thereof.

The vapor deposition may be carried out by a chemical vapor deposition (CVD). The chemical vapor deposition may be thermal chemical vapor deposition, plasma-enhanced chemical vapor deposition, or low pressure chemical vapor deposition.

The vapor procedure may be carried out at a temperature in a range of at about 700° C. to about 1000° C., or about 700° C. to about 900° C.

According to the carbon coating, an amorphous carbon coating layer is formed on the surface of the secondary particles.

If the secondary particle is mixed with the amorphous carbon precursor, a mixing ratio of the secondary particle and the amorphous carbon precursor may be in a range of about 95:5 to about 30:70 by weight ratio or about 90:10 to about 40:60 by weight ratio.

The heat-treatment may be carried out at a temperature in a range of about 600° C. to about 1,000° C. In the heat-treatment, the amorphous carbon precursor may be converted into an amorphous carbon, thereby preparing an amorphous carbon coating layer.

### Rechargeable Lithium Battery

Another example embodiment includes a rechargeable lithium battery including the negative electrode, a positive electrode, and an electrolyte.

### Negative Electrode:

The negative electrode includes a current collector and a negative active material layer formed on the current collector and including the negative active material according to one or more example embodiments. The negative active material layer includes the negative active material and may further include a binder and/or a conductive material.

The negative active material according to one or more example embodiments is included as a first negative active material, and crystalline carbon may be included as a second negative active material. A mixing ratio of the first negative active material to the second negative active material may be about 80:20 to about 90:10 by weight ratio. In another example embodiment, the negative active material may include the first negative active material and the second negative active material at a weight ratio in a range of about 85:15 to about 90:10.

In the negative active material layer, an amount of the negative active material may be in a range of about 90 wt % to about 99 wt % based on the total 100 wt % of the negative active material layer. An amount of the binder may be in a range of about 1 wt % to about 5 wt % based on the total 100 wt % of the negative active material layer. When the conductive material is further included, an amount of the binder may be in a range of about 0.5 wt % to about 5 wt % based on the total 100 wt % of the negative active material layer, and an amount of the conductive material may be in a range of about 0.5 wt % to about 5 wt % based on the total 100 wt % of the negative active material layer.

The binder improves binding properties of negative active material particles with one another and with a current collector. The binder may be or include a non-aqueous binder, an aqueous binder, a dry binder or combination thereof.

The non-aqueous binder may be or include at least one of polyvinyl chloride, carboxylated polyvinyl chloride, polyvinyl fluoride, an ethylene propylene copolymer, polystyrene, polyurethane, polytetrafluoroethylene, polyvinylidene fluoride, polyethylene, polypropylene, polyamideimide, polyimide, or a combination thereof.

The aqueous binder may be or include at least one of a styrene-butadiene rubber, a (meth) acrylated styrene-butadiene rubber, a (meth)acrylonitrile-butadiene rubber, a (meth)acryl rubber, a butyl rubber, a fluorine rubber, polyethylene oxide, polyvinylpyrrolidone, polyepichlorohydrin, polyphosphazene, poly(meth)acrylonitrile, an ethylene propylene diene copolymer, polyvinyl pyridine, chlorosulfonated polyethylene, latex, a polyester resin, a (meth)acrylic resin, a phenol resin, an epoxy resin, polyvinyl alcohol, or a combination thereof.

When the aqueous binder is used as a negative electrode binder, a cellulose-based compound may be further used to provide viscosity. The cellulose-based compound includes one or more of carboxymethyl cellulose, hydroxypropylmethyl cellulose, methyl cellulose, or alkali metal salts thereof. The alkali metal may be or include at least one of Na, K, or Li.

The dry binder may be or include a polymer material that is capable of being fibrous. For example, the dry binder may be or include at least one of polytetrafluoroethylene, polyvinylidene fluoride, a polyvinylidene fluoride-hexafluoropropylene copolymer, polyethylene oxide, or a combination thereof.

The conductive material is included to provide electrode conductivity, and any electrically conductive material may be used as a conductive material unless the electrochemically conductive material causes a chemical change in the battery. Examples of the conductive material may be or include a carbon-based material such as or including at least one of natural graphite, artificial graphite, carbon black, acetylene black, ketjen black, a carbon fiber, a carbon nanofiber, carbon nanotube, or the like; a metal-based material of a metal powder or a metal fiber including at least one of copper, nickel, aluminum, silver, and the like; a conductive polymer such as a polyphenylene derivative; or a mixture thereof.

The negative current collector may include at least one of a copper foil, a nickel foil, a stainless steel foil, a titanium foil, a nickel foam, a copper foam, a polymer substrate coated with a conductive metal, and a combination thereof.

### Positive Electrode:

The positive electrode may include a current collector and a positive active material layer on the current collector. The positive active material layer includes a positive active material, and may further include a binder and/or a conductive material.

For example, the positive electrode may further include an additive that may constitute a sacrificial positive electrode.

An amount of the positive active material may be in a range of about 90 wt % to about 99.5 wt % based on 100 wt % of the positive active material layer, and amounts of the binder and the conductive material may be respectively 0.5 wt % to 5 wt % based on 100 wt % of the positive active material layer.

The positive active material may include a compound (lithiated intercalation compound) that is capable of intercalating and deintercalating lithium. In some example embodiments, at least one of a composite oxide of lithium and a metal such as or including at least one of cobalt, manganese, nickel, or combinations thereof may be used.

The composite oxide may be or include a lithium transition metal composite oxide, and examples thereof may include at least one of lithium nickel-based oxide, lithium cobalt-based oxide, lithium manganese-based oxide, lithium iron phosphate-based compound, cobalt-free nickel-manganese-based oxide, or a combination thereof.

For example, the following compounds represented by any one of the following chemical formulas may be used. LiₐA_{1-b}X_{b}O_{2-c}D_{c} (0.90≤a≤1.8, 0≤b≤0.5, 0≤c≤0.05); LiₐMn_{2-b}X_{b}O_{4-c}D_{c} (0.90≤a≥1.8, 0≤b≥0.5, 0≤c≤0.05); LiₐNi_{1-b-c}Co_{b}X_{c}O_{2-α}D_{α} (0.90≤a≤1.8, 0≤b≤0.5, 0≤c≤0.05, 0<α<2); LiₐNi_{1-b-c}Mn_{b}X_{c}O_{2-α}D_{α} (0.90≤a≤1.8, 0≤b≤0.5, 0≤c≤0.05, 0<α<2); LiₐNi_{b}Co_{c}L¹_{d}GₑO₂ (0.90≤a≤1.8, 0≤b≤0.9, 0≤c≤0.5, 0≤d≤0.5, 0≤e≤0.1); LiₐNiG_{b}O₂ (0.90≤a≤1.8, 0.001≤b≤0.1); LiₐCoG_{b}O₂ (0.90≤a≤1.8, 0.001≤b≤0.1); LiₐMn_{1-b}G_{b}O₂ (0.90≤a≤1.8, 0.001≤b≤0.1); LiₐMn₂GbO₄ (0.90≤a≤1.8, 0.001≤b≤0.1); LiₐMn_{1-g}G_{g}PO₄ (0.90≤a≤1.8, 0≤g≤0.5); Li_{(3-f)}Fe₂(PO₄)₃ (0≤f≤2); LiₐFePO₄ (0.90≤a≤1.8).

In the above chemical formulas, A is or includes at least one of Ni, Co, Mn, or a combination thereof; X is or includes at least one of Al, Ni, Co, Mn, Cr, Fe, Mg, Sr, V, a rare earth element or a combination thereof; D is or includes at least one of O, F, S, P, or a combination thereof; G is or includes at least one of Al, Cr, Mn, Fe, Mg, La, Ce, Sr, V, or a combination thereof; and L¹ is or includes at least one of Mn, Al, or a combination thereof.

For example, the positive active material may be or include a high nickel-based positive active material having a nickel amount of greater than or equal to about 80 mol %, greater than or equal to about 85 mol %, greater than or equal to about 90 mol %, greater than or equal to about 91 mol %, or greater than or equal to about 94 mol % and less than or equal to about 99 mol % based on 100 mol % of the metal excluding lithium in the lithium transition metal composite oxide. The high-nickel-based positive active material may realize high capacity and may be applied to a high-capacity, high-density rechargeable lithium battery.

The binder improves binding properties of positive active material particles with one another and with a current collector. Examples of the binder may be or include at least one of polyvinyl alcohol, carboxymethyl cellulose, hydroxypropyl cellulose, diacetyl cellulose, polyvinyl chloride, carboxylated polyvinyl chloride, polyvinyl fluoride, an ethylene oxide-containing polymer, polyvinyl pyrrolidone, polyurethane, polytetrafluoroethylene, polyvinylidene fluoride, polyethylene, polypropylene, a styrene butadiene rubber, a (meth)acrylated styrene butadiene rubber, an epoxy resin, a (meth)acrylic resin, a polyester resin, nylon, or the like, but are not limited thereto.

The conductive material is included to provide electrode conductivity, and any electrically conductive material may be used as a conductive material unless the electrically conductive material causes a chemical change to the battery. Examples of the conductive material may include a carbonaceous material such as or including at least one of natural graphite, artificial graphite, carbon black, acetylene black, Ketjen black, carbon fiber, carbon nanofiber, carbon nanotube, or the like; a metal-based material of a metal powder or a metal fiber including at least one of copper, nickel, aluminum, silver, or the like; a conductive polymer such as a polyphenylene derivative; or a mixture thereof.

The current collector may include Al, but is not limited thereto.

### Electrolyte:

The electrolyte includes a non-aqueous organic solvent and a lithium salt.

The non-aqueous organic solvent may be a medium for transmitting ions taking part in the electrochemical reaction of a battery.

The non-aqueous organic solvent may include at least one of a carbonate-based, ester-based, ether-based, ketone-based, alcohol-based, or aprotic solvent.

The carbonate-based solvent may include at least one of dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), butylene carbonate (BC), or the like.

The ester-based solvent may include at least one of methyl acetate, ethyl acetate, n-propyl acetate, dimethyl acetate, methyl propionate, ethyl propionate, decanolide, mevalonolactone, valerolactone, caprolactone, or the like.

The ether-based solvent may include at least one of dibutyl ether, tetraglyme, diglyme, dimethoxyethane, 2-methyltetrahydrofuran, 2,5-dimethyltetrahydrofuran, tetrahydrofuran, or the like. The ketone-based solvent may include cyclohexanone, or the like. The alcohol-based solvent may include at least one of ethanol, isopropyl alcohol, and the like and the aprotic solvent may include at least one of nitriles such as R—CN (wherein R is a C2 to C20 linear, branched, or cyclic hydrocarbon group, and may include a double bond, an aromatic ring, or an ether bond, and the like); amides such as dimethylformamide; dioxolanes such as 1,3-dioxolane, 1,4-dioxolane, and the like; sulfolanes, or the like.

The non-aqueous organic solvent may be used alone or in a mixture of two or more solvents.

If the carbonate-based solvent is used, the cyclic carbonate and the linear carbonate may be used together therewith, and the cyclic carbonate and the linear carbonate may be mixed at a volume ratio of about 1:1 to about 1:9.

The lithium salt dissolved in an organic solvent supplies a battery with lithium ions, operates the rechargeable lithium battery, and improves transportation of the lithium ions between positive and negative electrodes. Examples of the lithium salt include one or at least two supporting electrolyte salt including at least one of LiPF₆, LiBF₄, LiSbF₆, LiAsF₆, LiClO₄, LiAlO₂, LiAlCl₄, LiPO₂F₂, LiCl, LiI, LiN(SO₃C₂F₅)₂, Li(FSO₂)₂N (lithium bis(fluorosulfonyl)imide, LiFSI), LiC₄F₉SO₃, LiN(CₓF₂ₓ₊₁SO₂)(C_{y}F_{2y+1}SO₂), where x and y are an integer of 1 to 20, lithium trifluoromethane sulfonate, lithium tetrafluoroethane sulfonate, lithium difluorobis(oxalato)phosphate (LiDFBOP), lithium bis(oxalato) borate (LiBOB).

### Separator:

A separator may be disposed between the positive electrode and the negative electrode depending on a type of a rechargeable lithium battery. The separator may include at least one of polyethylene, polypropylene, polyvinylidene fluoride or multi-layers thereof having two or more layers and may be or include a mixed multilayer such as a polyethylene/polypropylene double-layered separator, a polyethylene/polypropylene/polyethylene triple-layered separator, a polypropylene/polyethylene/polypropylene triple-layered separator, and the like.

The separator may include a porous substrate and a coating layer including an organic material, an inorganic material, or a combination thereof on one or both surfaces of the porous substrate.

The porous substrate may be or include a film formed of any one or more of polyolefin such as polyethylene and polypropylene, polyester such as polyethylene terephthalate and polybutylene terephthalate, polyacetal, polyamide, polyimide, polycarbonate, polyether ketone, polyarylether ketone, polyetherimide, polyamideimide, polybenzimidazole, polyethersulfone, polyphenylene oxide, a cyclic olefin copolymer, polyphenylene sulfide, polyethylene naphthalate, a glass fiber, TEFLON, and polytetrafluoroethylene, or a copolymer or mixture of two or more thereof.

The organic material may include a polyvinylidene fluoride-based polymer or a (meth)acryl-based polymer.

The inorganic material may be or include an inorganic particle including at least one of Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, or a combination thereof, but is not limited thereto.

The organic material and an inorganic material may be mixed in one coating layer, or a coating layer including an organic material and a coating layer including an inorganic material may be stacked.

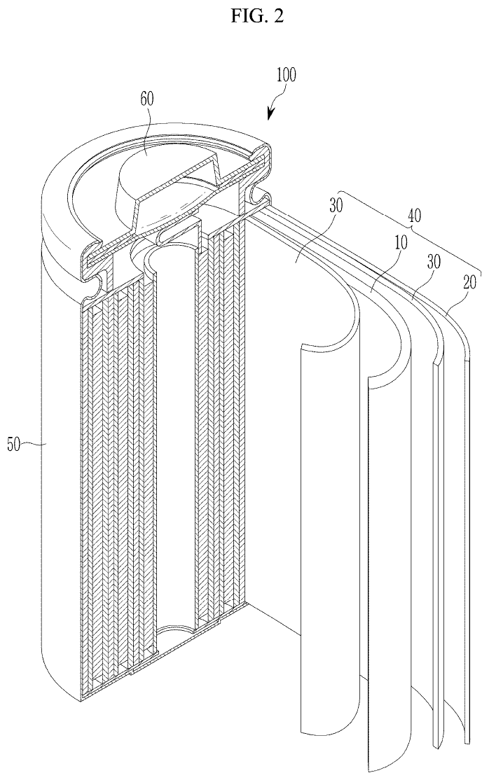

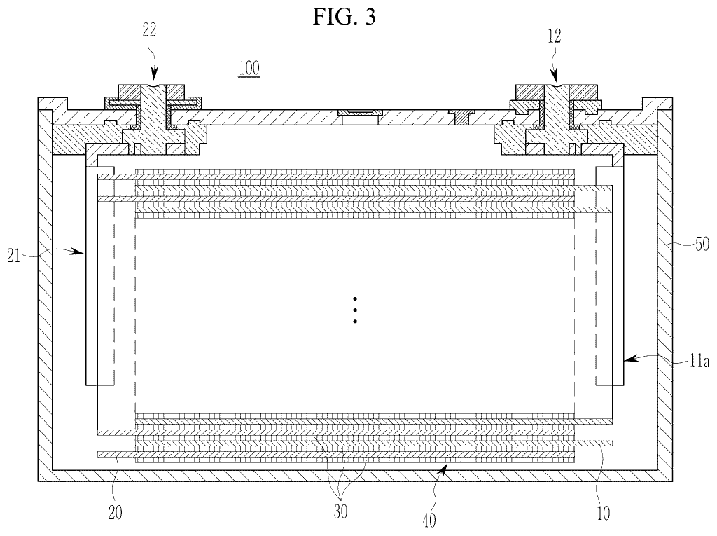

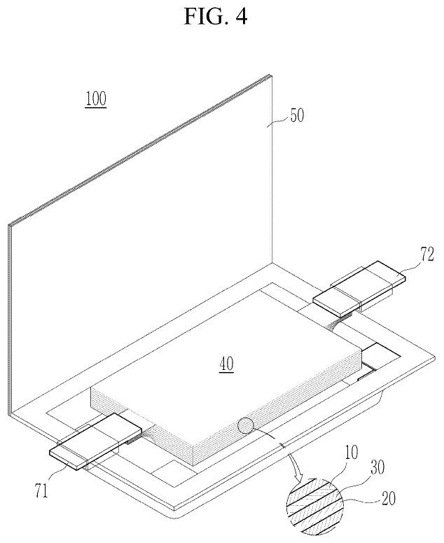

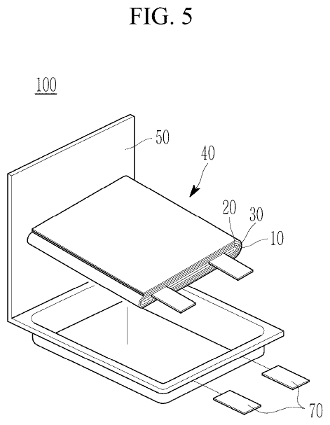

The rechargeable lithium battery may be classified into cylindrical, prismatic, pouch, or coin-type batteries, and the like depending on their shape. FIG. 2 to FIG. 5 are schematic views illustrating a rechargeable lithium battery according to an example embodiment, and FIG. 2 illustrates a cylindrical battery, FIG. 3 illustrates a prismatic battery, and FIG. 4 and FIG. 5 illustrate pouch-type batteries. Referring to FIGS. 2 to 5, the rechargeable lithium battery 100 may include an electrode assembly 40 including a separator 30 between a positive electrode 10 and a negative electrode 20, and a case 50 in which the electrode assembly 40 is included. The positive electrode 10, the negative electrode 20, and the separator 30 may be impregnated with an electrolyte (not shown). The rechargeable lithium battery 100 may include a sealing member 60 sealing the case 50, as shown in FIG. 2. In FIG. 3, the rechargeable lithium battery 100 may include a positive electrode lead tab 11a and a positive terminal 12, a negative electrode lead tab 21, and a negative terminal 22. As shown in FIG. 4 and FIG. 5, the rechargeable lithium battery 100 may include an electrode tab 70 illustrated in FIG. 5, which may form an electrical path for inducing the current formed in the electrode assembly 40 to the outside of the battery 100, and a positive electrode tab 71 and a negative electrode tab 72 illustrated in FIG. 4, also forming an electrical path for inducing the current formed in the electrode assembly 40 to the outside of the battery 100.

The rechargeable lithium battery according to an example embodiment may be applicable in, e.g., automobiles, mobile phones, and/or various types of electric devices, as non-limiting examples.

The following Examples and Comparative Examples are provided in order to highlight characteristics of one or more example embodiments, but it will be understood that the Examples and Comparative Examples are not to be construed as limiting the scope of the example embodiments, nor are the Comparative Examples to be construed as being outside the scope of the example embodiments. Further, it will be understood that the example embodiments are not limited to the particular details described in the Examples and Comparative Example.

### Example 1

A porous substrate (SiO₂) with an average particle diameter (D50) of 4 μm was prepared. In the porous substrate, an average particle diameter of the pore was 20 nm and the porosity was 75%.

A chemical vapor deposition (primary deposition) was conducted on the porous substrate using a SiH₄ gas at a gas flow rate of 100 sccm (measured at 0° C. and 1 atm) at 400° C. for 1 hour, thereby filling inside of the pores of the porous substrate with Si, thereby preparing primary particles in which Si was filled inside of the pores of the porous substrate (average particle diameter (D50) of primary particle: 5 μm). The SiH₄ gas was used in order to have a weight ratio of the porous substrate and Si to be 30:70.

The primary particles and a petroleum pitch were mixed at a weight ratio of 100:10 weight ratio, and an agglomeration by heat-treating in the agglomeration equipment was conducted thereon. According to the agglomeration, secondary particles was prepared (average particle diameter (D50) of the secondary particle: 13 μm).

A chemical vapor deposition (secondary deposition) using a C₂H₂ gas was carried out for the secondary particles at 700° C. to form a soft carbon coating layer on the surface of the secondary particles, thereby preparing a negative active material. The prepared negative active material had a porosity of 1%, and the soft carbon coating layer had a thickness of 10 nm. The porosity of the negative active material was obtained by measuring the pore volume of the negative active material using a specific surface area measurement device (available from Micromeritics Instrument Corporation) and multiplying the resulting pore volume by a true density of the negative active material.

The negative active material was used as a first negative active material, 97.5 wt % of a mixed negative active material of the first negative active material and the natural graphite second negative active material (a mixing ratio of the first and second negative active materials=90:10 weight ratio), 1.5 wt % of carboxymethyl cellulose, and 1 wt % of a styrene butadiene rubber, were mixed in a water solvent to prepare a negative active material layer slurry.

The negative active material layer slurry was coated on a Cu foil current collector, dried and pressurized under a general procedure to prepare a negative electrode including the current collector and a negative active material layer formed on the current collector.

96 wt % of a LiNi_{0.8}Co_{0.1}Mn_{0.1}O₂ positive active material, 2 wt % of a ketjen black, and 2 wt % of polyvinylidene fluoride were mixed in an N-methyl pyrrolidone solvent to prepare a positive active material layer slurry.

The positive active material slurry was coated on an Al foil current collector, dried and pressurized to prepare a positive electrode.

Using the negative electrode, a lithium metal counter electrode, and an electrolyte, a half-cell was fabricated by the general procedures.

Using the negative electrode, the positive electrode, and an electrolyte, a full cell was fabricated by the general procedures.

In the half-cell and full cell, as the electrolyte, 1M LiPF₆ dissolved in a mixed solvent of ethylene carbonate and dimethyl carbonate (3:7 volume ratio) was used.

### Example 2

A half-cell and a full cell were fabricated by the same procedure as in Example 1, with a difference that the porous substrate with an average particle diameter of 7 μm was used to prepare a negative active material with an average particle diameter (D50) of the primary particles of 8 μm and the porosity of 1%.

### Example 3

A half-cell and a full cell were fabricated by the same procedure as in Example 1, with a difference that the primary deposition was carried out for 120 minutes to prepare a negative active material with an average particle diameter (D50) of the primary particles of 5 μm and the porosity of 0.1%.

### Example 4

A half-cell and a full cell were fabricated by the same procedure as in Example 2, with a difference that the primary deposition was carried out for 120 minutes to prepare a negative active material with an average particle diameter (D50) of the primary particles of 8 μm and the porosity of 0.1%.

### Comparative Example 1

A half-cell and a full cell were fabricated by the same procedure as in Example 1, with a difference that the primary deposition was carried out for 30 minutes to prepare a negative active material with an average particle diameter (D50) of the primary particles of 5 μm and the porosity of 2.1%.

### Comparative Example 2

A half-cell and a full cell were fabricated by the same procedure as in Example 2, with a difference that the primary deposition was carried out for 30 minutes to prepare a negative active material with an average particle diameter (D50) of the primary particles of 8 μm and the porosity of 2.1%.

### Comparative Example 3

A chemical vapor deposition (primary deposition) was conducted on the porous substrate (SiO₂) with an average particle diameter (D50) of 15 μm using a SiH₄ gas at a gas flow rate of 100 sccm (measured at 0° C. and 1 atm) at 400° C. for 1 hour, thereby filling inside of the pores of the porous substrate with Si, thereby preparing macro particles in which Si was filled inside of the pores of the porous substrate (average particle diameter (D50) of primary particle: 16 μm).

A chemical vapor deposition using a C₂H₂ gas was carried out for the secondary particles at 700° C. to form a soft carbon coating layer on the surface of the macro particles, thereby preparing a negative active material. The prepared negative active material had a porosity of 1% and the soft carbon coating layer had a thickness of 10 nm.

A negative electrode, a half-cell, and a full cell were fabricated by the same procedure as in Example 1, with a difference of using the negative active material.

### Experimental Example 1) Evaluation of Specific Capacity

The half-cells according to Examples 1 to 4 and Comparative Examples 1 to 3 were once charged and discharged at 0.1 C to measure a specific capacity. The results are shown in Table 1.

### Experimental Example 2) Evaluation of Efficiency

The full cells according to Examples 1 to 4 and Comparative Examples 1 to 3 were once charged and discharged at 0.1 C, and a ratio of the measured discharge capacity relative to the measured charge capacity was calculated. The results are shown in Table 1, as efficiency.

### Experimental Example 3) Evaluation of Cycle-Life Characteristic

The half-cells according to Examples 1 to 4 and Comparative Examples 1 to 3 were charged and discharged at 1 C for 400 cycles. A ratio of capacity at each cycle relative to 1st discharge capacity was measured. The number of cycles if the ratio of capacity, e.g., capacity retention was reached to 80% is shown in Table 1, as cycle number at cycle-life sharply decreased.

TABLE 1

| | Specific | | Cycle number at which |
|---|---|---|---|
| | capacity | Efficiency | cycle-life sharply |
| | (mAh/g) | (%) | decreased (No.) |
| Example 1 | 2200 | 85 | 570 |
| Example 2 | 2280 | 85 | 550 |
| Example 3 | 2180 | 86 | 600 |
| Example 4 | 2230 | 86 | 580 |
| Comparative Example 1 | 2250 | 84 | 440 |
| Comparative Example 2 | 2350 | 82 | 460 |
| Comparative Example 3 | 2650 | 64 | 150 |

As shown in Table 1, Examples 1 to 4 exhibited high specific capacity and efficiency, and desired or improved cycle-life characteristic.

Whereas, Comparative Examples 1 and 2 including the negative active material having the porosity of more than 2% exhibited deteriorated cycle-life characteristic, and Comparative Example 3 including the negative active material consisting of macro primary particles with particle size of 16 μm exhibited abruptly deteriorated efficiency and cycle-life characteristics.

While this disclosure has been described in connection with what is presently considered to be practical example embodiments, it is to be understood that the disclosure is not limited to the disclosed example embodiments, but, on the contrary, is intended to cover various modifications and equivalent arrangements included within the spirit and scope of the appended claims.

What is claimed is:

1. A negative active material, comprising:
secondary particles comprising aggregated primary particles, the primary particles comprising a substrate in which pores are formed, the pores being filled with amorphous Si; and
an amorphous carbon coating layer on a surface of the secondary particle,
wherein the primary particles have a size in a range of about 1 μm to about 15 μm, and,
the negative active material has a porosity in a range of about 2% or less.

2. The negative active material as claimed in claim 1, wherein the pore size is in a range of about 1 nm to about 100 nm.

3. The negative active material as claimed in claim 1, wherein the substrate has a porosity in a range of about 30% to about 90%.

4. The negative active material as claimed in claim 1, wherein the negative active material has a porosity in a range of about 0.1% to about 2%.

5. The negative active material as claimed in claim 1, wherein the primary particles have a size in a range of about 3 μm to about 14 μm.

6. The negative active material as claimed in claim 1, wherein an amount of the amorphous Si is in a range of about 19 wt % to about 70 wt % based on 100 wt % of the negative active material.

7. The negative active material as claimed in claim 1, wherein an amount of the substrate is in a range of about 29 wt % to about 80 wt % based on about 100 wt % of the negative active material.

8. The negative active material as claimed in claim 1, wherein an amount of the amorphous carbon is in a range of about 1 wt % to about 25 wt % based on 100 wt % of the negative active material.

9. The negative active material as claimed in claim 1, wherein the amorphous carbon coating layer has a thickness greater than about 0 nm and equal to about 2 μm or less.

10. The negative active material as claimed in claim 1, wherein the secondary particles further comprise amorphous carbon.

11. The negative active material as claimed in claim 1, wherein the substrate comprises at least one of Al₂O₃, ZrO₂, SiO₂, TiO₂, SiC, and C (carbon).

12. A method of preparing a negative active material, the method comprising:
vapor coating Si on a porous substrate in which pores are formed to prepare primary particles filled with an amorphous Si in the pores;
aggregating the primary particles to form secondary particles; and
forming an amorphous carbon coating layer on the secondary particles.

13. The method of preparing a negative active material as claimed in claim 12, wherein the porous substrate has a porosity in a range of about 30% to about 90%.

14. The method of preparing a negative active material as claimed in claim 12, wherein the pore size is in a range of about 1 nm to about 100 nm.

15. The method of preparing a negative active material as claimed in claim 12, wherein the vapor coating is carried out using a Si-included gas comprising at least one of a SiH₄ gas, a Si₂H₆ gas, and a Si₃H₈ gas.

16. The method of preparing a negative active material as claimed in claim 12, wherein the aggregating is carried out by using an amorphous carbon precursor.

17. The method of preparing a negative active material as claimed in claim 12, wherein the forming the amorphous carbon coating layer is carried out by using an amorphous carbon precursor gas.

18. A rechargeable lithium battery, comprising:
a negative electrode comprising the negative active material of claim 1;
a positive electrode; and
an electrolyte.
